(19) United States
(12) Patent Application Publication
(10) Pub. No.: US 2003/0008617 A1
(43) Pub. Date: Jan. 9, 2003

(54) Variable band-pass filter unit and communication apparatus using the same

(75) Inventors: Kenji Tamaru, Iwate (JP); Takashi Shiba, Iwate (JP); Masao Oguri, Iwate (JP)

Correspondence Address: CROWELL & MORING LLP, INTELLECTUAL PROPERTY GROUP, P.O. BOX 14300, WASHINGTON, DC, 20044-4300, US

(73) Assignee: Hitachi Media Electronics Co., Ltd.

(21) Appl. No.: 10/188,078

(22) Filed: Jul. 3, 2002

(30) Foreign Application Priority Data
Jul. 9, 2001 (JP) 2001-208203

(51) Int. Cl. H04B 1/68

(52) U.S. Cl. 455/46; 455/339; 455/336; 455/334

(57) ABSTRACT

A variable band-pass filter unit which is free from deterioration in throughput or incapability of communication even if jamming signals are inputted.

A variable band-pass filter circuit has at least two variable trap circuits. The variable trap circuits are constituted by the combination of resonators and variable capacitance diodes for band blocking. The variable band-pass filter circuit passes only a desired signal between variable trap frequencies of the variable trap circuits. Only a desired frequency band is made variable in accordance with frequency hopping.

### FIELD OF THE INVENTION

The present invention relates to a jamming wave suppressor of a short-range wireless data communication apparatus having a frequency hopping function chiefly in spread spectrum communication, and particularly relates to a variable band-pass filter unit having a signal pass band formed between at least two variable traps and having a narrow bandwidth to pass only a desired signal, and having a control function to make the signal pass band variable in accordance with a frequency hopping pattern; and a communication apparatus using the variable band-pass filter unit.

### DESCRIPTION OF THE RELATED ART

Related-art variable band-pass filter circuits for use in a communication apparatus having a frequency hopping function are designed so that the bands of respective filters are set to be adjacent to each other, and a fixed frequency band of one of the filters is selected by switching (for example, see Japanese Patent Laid-Open No. 120768/1994).

The 2.4-GHz band frequency used by a short-range wireless data communication apparatus is flooded with various signals from microwave ovens, wireless LANs (see the IEEE802.11 standard) and the like, so that the problem of radio interference therewith has been pointed out. Most RF chips for use in the short-range wireless data communication apparatus adopt a direct conversion system in order to save the cost and miniaturize the apparatus.

FIG. 11 shows 1) a receiver sensitivity characteristic when only a desired signal is inputted, and 2) a receiver sensitivity characteristic when a desired signal and a jamming signal at least 5 MHz distant from the desired signal and with power of −20 dBm are inputted, to a receiver using a direct conversion system. As is apparent from FIG. 11, when the jamming signal is inputted into the frequency-hopping band (2,400 MHz-2,483.5 MHz) of the short-range wireless data communication apparatus, the receiver sensitivity deteriorates by about 15 dB. Thus, a real apparatus may deteriorate in throughput or fall into communication incapability.

A short-range wireless data communication apparatus is typically designed as follows. That is, a dielectric filter, an LC filter, a surface acoustic wave filter, or the like, is used as an RF filter so as to pass signals only in a frequency-hopping band (2,400 MHz-2,483.5 MHz) but suppress signals in any other band. In such a case, if a jamming signal enters the frequency-hopping band, the jamming signal cannot be suppressed by the RF filter.

In the related art, as described above, there is adopted a method in which a fixed frequency band is changed for each frequency-hopping channel. According to this method, desired signals are allowed to pass only a really required channel band while jamming signals are suppressed in the other bands. The method is therefore effective against jamming in the range of 2,400 MHz-2,483.5 MHz.

However, the short-range wireless data communication apparatus has 79 channels. When all the channel bands are established by surface acoustic wave filters, the volume of the surface acoustic wave filters increases considerably so that the apparatus increases in scale and weight. Further, there is a disadvantage that the cost becomes very high.

An object of the present invention is to solve the foregoing problems in the related art, that is, to provide a variable band-pass filter unit in which deterioration in throughput or falling into communication incapability is reduced even in case that a high power jamming signal is inputted, and to provide a communication apparatus using the variable band-pass filter unit.

### SUMMARY OF THE INVENTION

To attain the foregoing object, according to a first aspect of the invention, there is provided a variable band-pass filter unit which uses a variable band-pass filter circuit having at least two variable trap circuits and a control voltage input terminal. The variable trap circuits are constituted by a low pass filter, a high pass filter, and so on, and each of the variable trap circuits has a combination of resonators and variable capacitance diodes for band blocking so that a signal pass band for passing only a desired signal is formed between variable trap frequencies of the variable trap circuits. The variable capacitance diodes are applied with a plurality of hopping control voltages from the control voltage input terminal. The variable band-pass filter unit has a feature in that the signal pass band is made variable in accordance with the plurality of hopping control voltages.

To attain the foregoing object, according to a second aspect of the invention, there is provided a communication apparatus including:

a variable band-pass filter circuit having at least two variable trap circuits and a control voltage input terminal, each of the variable trap circuits having a combination of resonators and variable capacitance diodes for band blocking so that a signal pass band for passing only a desired signal is formed between variable trap frequencies of the variable trap circuits, the variable capacitance diodes being applied with a hopping control voltage from the control voltage input terminal; and

a base band signal processing portion for producing a plurality of hopping control voltages in accordance with hopping patterns;

wherein one of the hopping control voltages from the base band signal processing portion is applied to the control voltage input terminal of the variable band-pass filter circuit so that the signal pass band is made variable in accordance with the plurality of hopping control voltages to thereby pass a desired signal wave but suppress jamming waves.

To attain the foregoing object, according to a third aspect of the invention, there is provided a communication apparatus including:

a variable band-pass filter circuit having at least two variable trap circuits and a control voltage input terminal, each of the variable trap circuits having a combination of resonators and variable capacitance diodes for band blocking so that a signal pass band for passing only a desired signal is formed between variable trap frequencies of the variable trap circuits, the variable capacitance diodes being applied with a hopping control voltage from the control voltage input terminal; and

a radio frequency modulation circuit including a voltage control oscillator for processing an output signal from the variable band-pass filter circuit;

wherein a tuning voltage of the voltage control oscillator for setting a channel is applied as a hopping control voltage to the control voltage input terminal of the variable band-pass filter circuit so that the signal pass band is made variable in accordance with a plurality of hopping control voltages to thereby pass a desired signal wave but suppress jamming waves.

With such a configuration according to the invention, only a desired channel band can be made variable in accordance with a frequency-hopping pattern. Accordingly, even if a comparatively high power jamming signal is inputted, the unnecessary jamming signal can be suppressed by the variable band-pass filter circuit according to the invention. Thus, deterioration in throughput or falling into communication incapability can be reduced.

### BRIEF DESCRIPTION OF THE DRAWINGS

FIG. 1 is a circuit diagram of a variable band-pass filter unit according to a first embodiment of the invention;

FIG. 2 is a filter characteristic diagram for explaining the principle of operation of a variable band-pass filter circuit;

FIG. 3 is a filter characteristic diagram for explaining the principle of operation of the variable band-pass filter circuit;

FIG. 4 is a filter characteristic diagram for explaining the principle of operation of the variable band-pass filter circuit;

FIG. 5 is a characteristic diagram of a variable capacitance diode for use in the variable band-pass filter circuit;

FIG. 6 is a circuit diagram of a variable band-pass filter unit according to a second embodiment of the invention;

FIG. 7 is a circuit diagram of a short-range wireless data communication apparatus according to a seventh embodiment of the invention;

FIG. 8 is a block diagram of a short-range wireless data communication apparatus according to an eighth embodiment of the invention;

FIG. 9 is a graph for specifically explaining the switching of channels in the short-range wireless data communication apparatus;

FIG. 10 is a block diagram of a short-range wireless data communication apparatus according to a ninth embodiment of the invention; and

FIG. 11 is a receiver sensitivity characteristic diagram showing the receiver sensitivity characteristic when only a desired signal is inputted and the receiver sensitivity characteristic when a jamming signal is also inputted.

### DESCRIPTION OF THE PREFERRED EMBODIMENTS

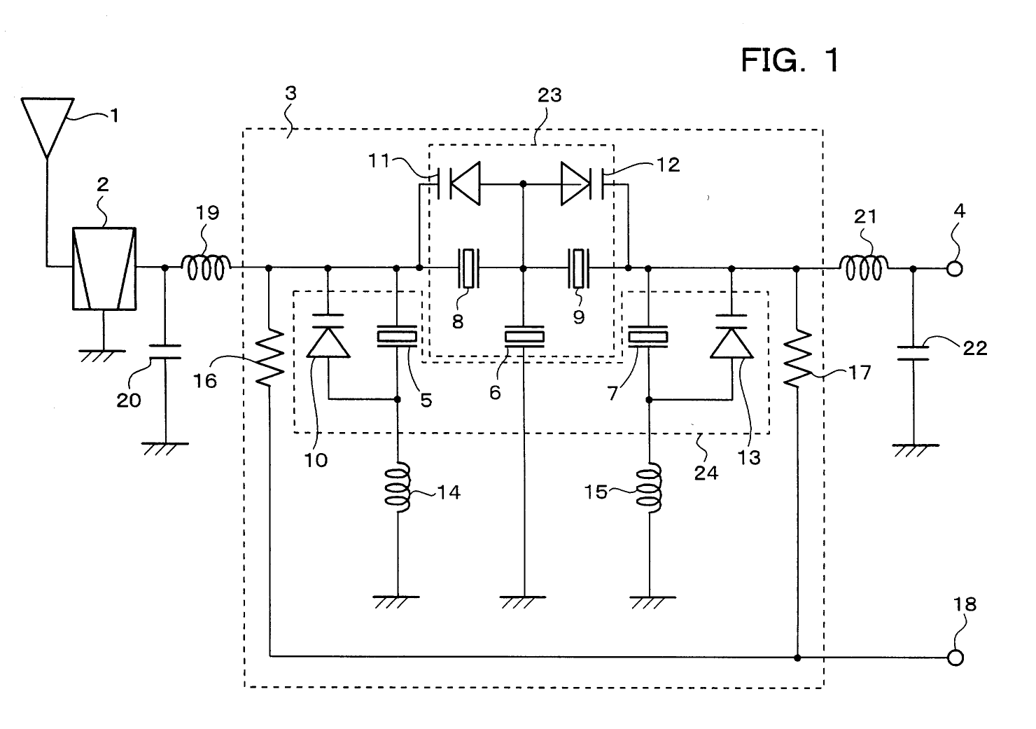

Embodiments of the invention will be described below with reference to the drawings. FIG. 1 is a circuit diagram of a variable band-pass filter unit used in an RF transmitting/receiving portion in a short-range wireless data communication apparatus according to a first embodiment of the invention.

In short-range wireless data communication, a frequency hopping system of spread spectrum communication is used for frequency hopping carried out with 1,600 hops per seconds. For the frequency band of the frequency hopping, the bandwidth of 83.5 MHz between 2,400 MHz and 2,483.5 MHz is secured to have a hopping pattern in which 79 channels of GFSK-modulated signals each having a bandwidth of about 1 MHz are allocated to the frequency band at the interval of 1 MHz.

In FIG. 1, a desired signal is supplied from an antenna 1 to a variable band-pass filter circuit 3 through an RF filter 2 and a matching circuit constituted by a capacitor 20 and a coil 19. As the RF filter 2, there is used a surface acoustic wave filter which passes signals in only the frequency-hopping frequency band (2,400 MHz-2,483.5 MHz) and suppresses unnecessary jamming signals out of the band.

The variable band-pass filter circuit 3 has resonators 5 to 9 each constituted by a surface acoustic wave filter, variable capacitance diodes 10 to 13, coils 14 and 15, resistors 16 and 17, a control voltage input terminal 18, and so on, which are connected to one another as illustrated. Then, a low pass filter 23 is constituted by the resonators 6, 8 and 9 and the variable capacitance diodes 11 and 12, while a high pass filter 24 is constituted by the resonators 5 and 7 and the variable capacitance diodes 10 and 13.

With the frequency bandwidth set to be about ⅛ as wide as that of the RF filter 2, only desired signals near the GFSK-modulated signal band having a bandwidth of about 1 MHz are extracted. The desired signals are outputted from an output terminal 4 through a matching circuit constituted by a coil 21 and a capacitor 22.

As the bandwidth of the variable band-pass filter approaches the GFSK-modulated signal bandwidth of 1 MHz, the effect of the characteristic against jamming is enhanced. However, in consideration of the scattering of component constants in the variable band-pass filter circuit 3, the fluctuation of the component constants against temperature changes, and so on, the bandwidth of the variable band-pass filter is set to be about 10 MHz.

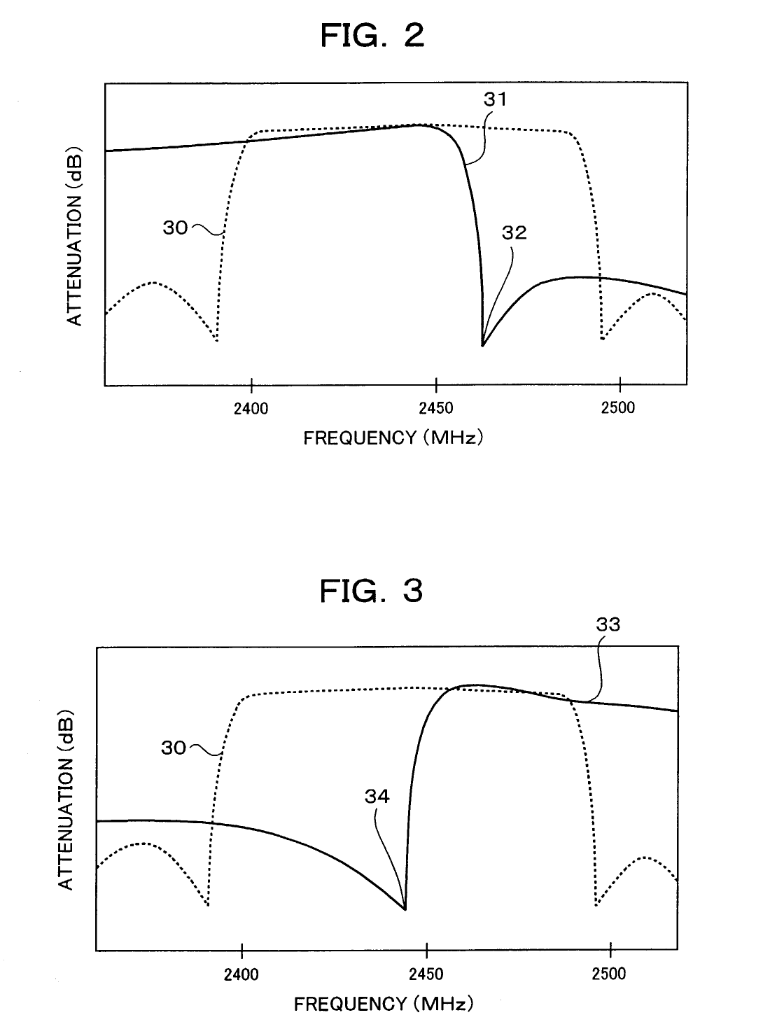

The principle of operation of the variable band-pass filter circuit 3 will be described with reference to FIGS. 2 to 4. FIG. 2 shows a characteristic 31 of the low pass filter 23 in FIG. 1. A band pass filter characteristic 30 shows the characteristic of the RF filter 2, securing an insertion loss of 3 dB or less in the frequency-hopping band of 2,400 MHz-2,483.5 MHz and attenuation of 20 dB or more in the other bands.

As for a trap 32, a hopping control voltage of about 0.3-2.7 V supplied from the control voltage input terminal 18 is applied to the variable capacitance diodes 11 and 12 through the resistors 16 and 17. As is understood from the variable capacitance diode characteristic in FIG. 5, the capacitance of the variable capacitance diodes 11 and 12 becomes comparatively large when the hopping control voltage applied thereto is comparatively low. Thus, the frequency of the trap 32 becomes low. On the contrary, when the hopping control voltage is comparative high, the capacitance of the variable capacitance diodes 11 and 12 becomes comparatively small. Thus, the frequency of the trap 32 becomes high.

FIG. 3 shows a characteristic 33 of the high pass filter 24 in FIG. 1. As for a trap 34, the hopping control voltage supplied from the control voltage input terminal 18 is applied to the variable capacitance diodes 10 and 13 through the resistors 16 and 17. As is understood from the variable capacitance diode characteristic in FIG. 5, the capacitance of the variable capacitance diodes 10 and 13 becomes comparatively large when the hopping control voltage applied thereto is comparatively low. Thus, the frequency of the trap 34 becomes low. On the contrary, when the hopping control voltage is comparative high, the capacitance of the variable capacitance diodes 10 and 13 becomes comparatively small. Thus, the frequency of the trap 34 becomes high.

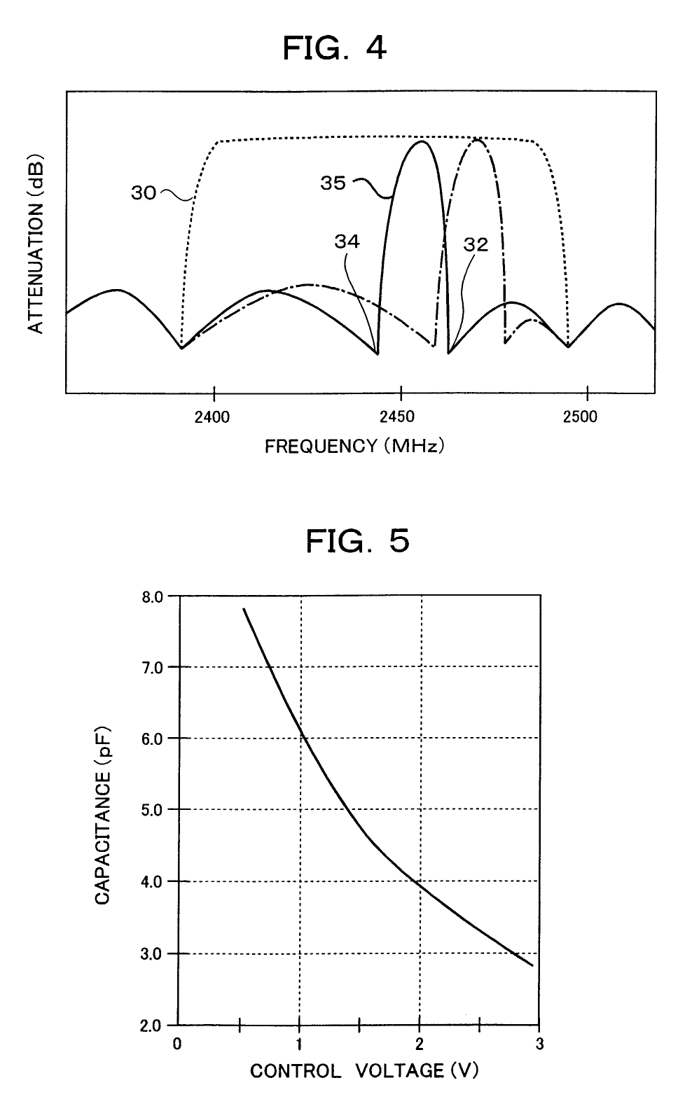

FIG. 4 shows a total filter characteristic 35 of the variable band-pass filter circuit 3. This total filter characteristic 35 is a characteristic in which the band pass filter characteristic 30, the low pass filter characteristic 31 and the high pass filter characteristic 33 have been combined. As described in FIGS. 2 and 3, the frequencies of the traps 32 and 34 move in the same direction in accordance with the hopping control voltage supplied from the control voltage input terminal 18. Thus, a substantially fixed bandwidth can be secured for the total filter characteristic 35.

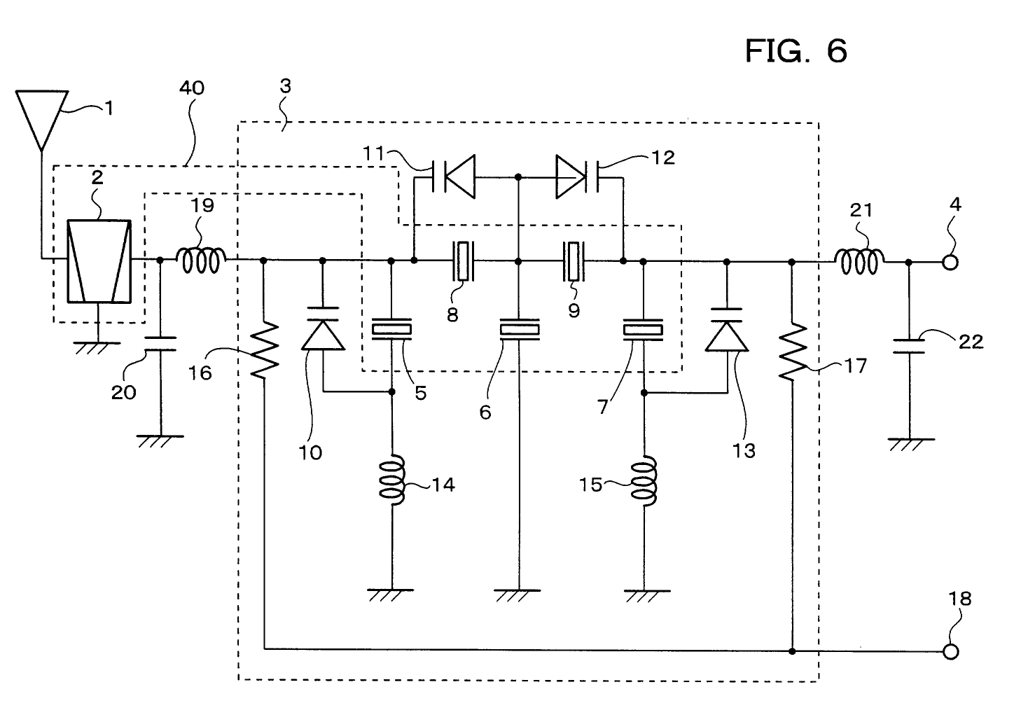

FIG. 6 shows a variable band-pass filter unit according to a second embodiment. This embodiment is different from the first embodiment shown in FIG. 1 in that the RF filter 2 constituted by a surface acoustic wave device and the resonators 5 to 9 are put into one and the same package 40. When the RF filter 2 and the resonators 5 to 9 are formed into one module in such a manner, the unit can be miniaturized while the cost can be reduced.

As a third embodiment, a dielectric filter is used as the RF filter 2 in the variable band-pass filter unit shown in FIG. 1. This embodiment has a feature in that the loss can be made so low that there is an effect on the improvement of the sensitivity of the communication apparatus. Further, when a low noise amplifier is provided between the RF filter 2 and the variable band-pass filter circuit 3, the sensitivity can be further enhanced.

As a fourth embodiment, an LC filter is used as the RF filter 2 in the variable band-pass filter unit shown in FIG. 1. This embodiment has a feature in that the cost can be reduced.

As a fifth embodiment, dielectric resonators are used as the resonators 5 to 9 in the variable band-pass filter unit shown in FIG. 1. This embodiment has a feature, in the same manner as the third embodiment, in that the loss can be made so low that the sensitivity of the communication apparatus can be improved.

As a sixth embodiment, LC resonators are used as the resonators 5 to 9 in the variable band-pass filter unit shown in FIG. 1. This embodiment has a feature, in the same manner as the fourth embodiment, in that the cost can be reduced.

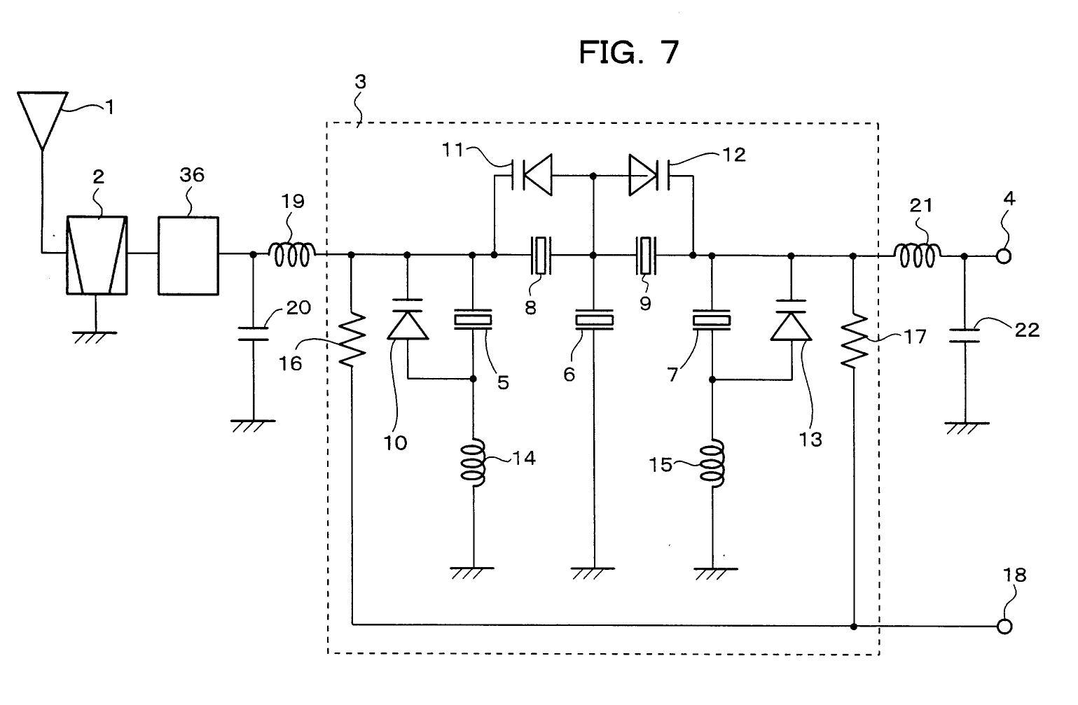

FIG. 7 shows a communication apparatus according to a seventh embodiment. In FIG. 7, a low noise amplifier 36 is provided between the RF filter 2 and the variable band-pass filter circuit 3. Thus, the sensitivity can be further enhanced.

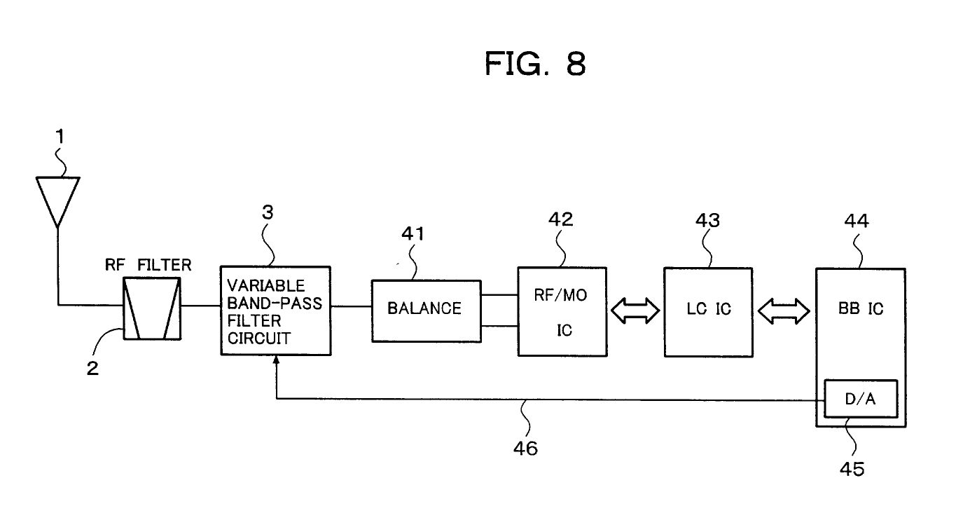

FIG. 8 shows a communication apparatus according to an eighth embodiment. FIG. 8 is a block diagram of a short-range wireless data communication apparatus using the variable band-pass filter circuit 3 shown in FIG. 1 or 6.

Of standard signal waves of the short-range wireless data communication apparatus, only a desired signal is extracted in the variable band-pass filter circuit 3, converted unbalanced-to-balanced in a balance (BALANCE) circuit 41 constituted by a balun and so on, and supplied to a radio-frequency modulation circuit (RF/MO IC) 42. The desired signal extracted thus is demodulated in the radio-frequency modulation circuit (RF/MO IC) 42, and subjected to data processing in a base band signal processing portion (BB IC) 44 through a link controller (LC IC) 43.

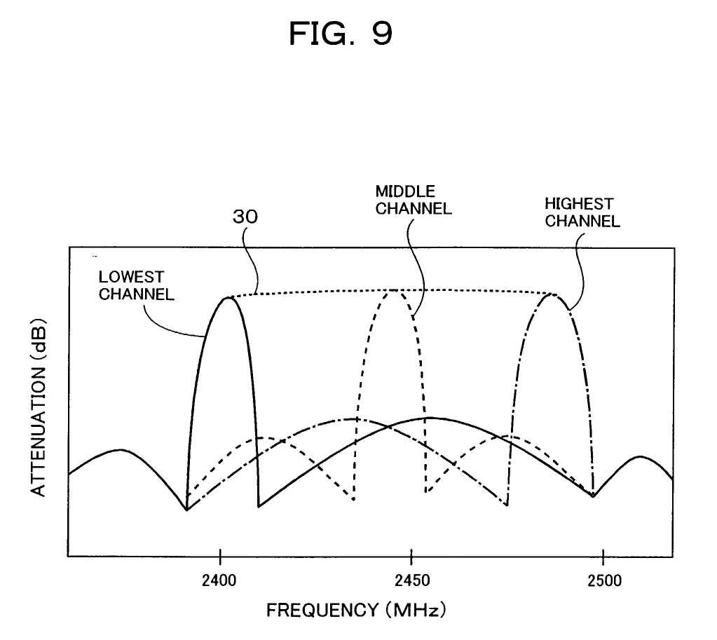

The base band signal processing portion 44 also plays a role to determine a hopping pattern of channels. Channel information from the base band signal processing portion 44 is outputted as a hopping control voltage 46 through a D/A converter 45. The hopping control voltage 46 is applied to the control voltage input terminal 18 (see FIGS. 1 and 6) of the variable band-pass filter circuit 3. The hopping control voltage 46 is, for example, set to be about 0.3 V at the time of the lowest channel switching, about 1.5 V at the time of middle channel switching, and about 2.7 V at the time of the highest channel switching, as shown in FIG. 9. In accordance with the switching of the hopping control voltage 46, 79 channels are switched automatically.

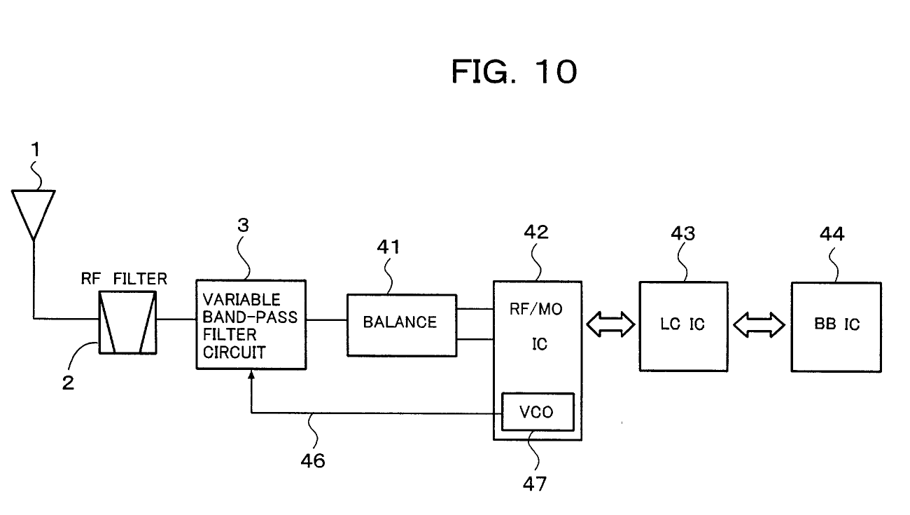

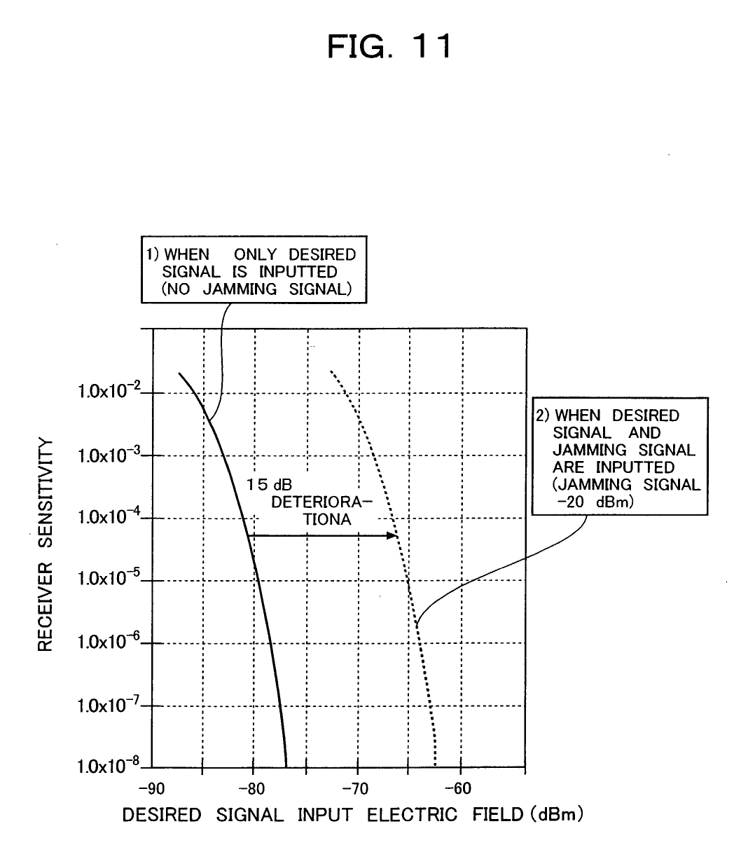

FIG. 10 shows a communication apparatus according to a ninth embodiment. Although the hopping control voltage 46 is supplied from the base band signal processing portion 44 in the eighth embodiment, a tuning voltage for setting a channel is supplied as the hopping control voltage 46 by a voltage control oscillator (VCO) 47 built in the radio-frequency modulation circuit (RF/MO IC) 42 in this embodiment. Although it is necessary in the eighth embodiment to add software for outputting the hopping control voltage 46, it is not necessary in this embodiment to add such software. Thus, it is possible to provide a communication apparatus at low cost.

Although description in each of the embodiments has been made on the case where a desired signal wave is a signal wave compliant with the short-range wireless data communication standards while a jamming wave is a signal wave from another electronic equipment such as a wireless LAN or a microwave oven, the invention is not limited thereto. For example, the desired signal wave may be a signal wave for use in a wireless LAN, and the jamming wave may be a signal wave compliant with the short-range wireless data communication standards or a signal wave from another electronic equipment such as a microwave oven. Different desired signal waves and different jamming waves are aimed at in accordance with the applications of the filter unit.

According to the invention, a variable band-pass filter circuit is used, in which a filter is formed to have much narrower bandwidth than receiver bandwidth required for frequency hopping. The band of the narrow-band filter is varied in accordance with the frequency hopping. Thus, even if a comparatively high power jamming signal enters the frequency-hopping receiver band, it is possible to reduce the deterioration of the receiver sensitivity characteristic.

What is claimed is:

1. A variable band-pass filter unit comprising:
a variable band-pass filter circuit having at least two variable trap circuits and a control voltage input terminal, each of said variable trap circuits having a combination of resonators and variable capacitance diodes for band blocking so that a signal pass band for passing only a desired signal is formed between variable trap frequencies of said variable trap circuits, said variable capacitance diodes being applied with a plurality of hopping control voltages from said control voltage input terminal;
wherein said signal pass band is made variable in accordance with said plurality of hopping control voltages.

2. A variable band-pass filter unit according to claim 1, wherein surface acoustic wave resonators are used as said resonators.

3. A variable band-pass filter unit according to claim 1, wherein dielectric resonators are used as said resonators.

4. A variable band-pass filter unit according to claim 1, wherein LC resonators are used as said resonators.

5. A variable band-pass filter unit according to any one of claims 1 to 4, wherein a band pass filter is provided before said variable band-pass filter circuit.

6. A variable band-pass filter unit according to claim 5, wherein a surface acoustic wave filter is used as said band pass filter.

7. A variable band-pass filter unit according to claim 5, wherein a dielectric filter is used as said band pass filter.

8. A variable band-pass filter unit according to claim 5, wherein an LC filter is used as said band pass filter.

9. A variable band-pass filter unit according to any one of claims 5 to 8, wherein said resonators used in said variable band-pass filter circuit and said filter used as said band pass filter are formed into one module.

10. A communication apparatus comprising:
a variable band-pass filter unit according to any one of claims 1 to 9.

11. A communication apparatus comprising:
a variable band-pass filter unit according to any one of claims 5 to 8; and
a low noise amplifier provided between a band pass filter and a variable band-pass filter circuit.

12. A communication apparatus comprising:
a variable band-pass filter circuit having at least two variable trap circuits and a control voltage input terminal, each of said variable trap circuits having a combination of resonators and variable capacitance diodes for band blocking so that a signal pass band for passing only a desired signal is formed between variable trap frequencies of said variable trap circuits, said variable capacitance diodes being applied with a hopping control voltage from said control voltage input terminal; and
a base band signal processing portion for producing a plurality of hopping control voltages in accordance with hopping patterns;
wherein one of said hopping control voltages from said base band signal processing portion is applied to said control voltage input terminal of said variable band-pass filter circuit so that said signal pass band is made variable in accordance with said plurality of hopping control voltages to thereby pass a desired signal wave but suppress jamming waves.

13. A communication apparatus comprising:
a variable band-pass filter circuit having at least two variable trap circuits and a control voltage input terminal, each of said variable trap circuits having a combination of resonators and variable capacitance diodes for band blocking so that a signal pass band for passing only a desired signal is formed between variable trap frequencies of said variable trap circuits, said variable capacitance diodes being applied with a hopping control voltage from said control voltage input terminal; and
a radio frequency modulation circuit including a voltage control oscillator for processing an output signal from said variable band-pass filter circuit;
wherein a tuning voltage of said voltage control oscillator for setting a channel is applied as a hopping control voltage to said control voltage input terminal of said variable band-pass filter circuit so that said signal pass band is made variable in accordance with a plurality of hopping control voltages to thereby pass a desired signal wave but suppress jamming waves.

14. A communication apparatus according to claim 12 or 13, wherein said communication apparatus is a short-range wireless data communication apparatus, and said variable band-pass filter circuit is provided in a radio frequency transmitting/receiving portion of said communication apparatus.

15. A communication apparatus according to any one of claims 12 to 14, wherein said desired signal wave is a signal wave compliant with short-range wireless data communication standards, while said jamming waves are signal waves from one of a wireless LAN and another electronic equipment.

16. A communication apparatus according to any one of claims 12 to 14, wherein said desired signal wave is a signal wave for use in a wireless LAN while said jamming waves are ones of signal waves compliant with short-range wireless data communication standards and signals waves from another electronic equipment.
